(19) United States
(12) Patent Application Publication
(10) Pub. No.: US 2010/0046640 A1
(43) Pub. Date: Feb. 25, 2010

(54) DECODING SYSTEM FOR EXECUTING ACCELERATED PROCESSING IN REAL TIME AND RELATED METHODS

(75) Inventors: Jae-Seob Shin, Seoul (KR); Sung-Gul Ryoo, Seoul (KR); Se-Hoon Son, Seoul (KR); Tae-Jin Kim, Seoul (KR)

Correspondence Address: THE NATH LAW GROUP, 112 South West Street, Alexandria, VA, 22314, US

(73) Assignee: PIXTREE TECHNOLOGIS, INC., Seoul (KR)

(21) Appl. No.: 11/993,170

(22) PCT Filed: Jun. 20, 2006
(86) PCT No.: PCT/KR2006/002354

§ 371 Date: Apr. 10, 2009

(30) Foreign Application Priority Data
Jun. 20, 2005 (KR) 10-2005-0052876

(51) Int. Cl. H04N 7/26

(52) U.S. Cl. 375/240.29; 375/E07.193

(57) ABSTRACT

A method of operating a video decoder system includes decoding an encoded video frame using a decoder control unit for determining whether the acceleration is required for respective decoding functional units and the degree thereof. This includes the decoder control unit receiving a target time value to be taken to decode a frame; the decoder control unit performing main processing including inverse transformation and motion prediction on a predetermined frame; the deblock unit providing a value of time taken to perform deblock filtering on a frame prior to the predetermined frame to the decoder control unit; the decoder control unit comparing a value of total time taken with the target time value, in which the received value of time taken for the deblock filtering of the previous frame and the value of time taken for the main processing are added; and the decoder control unit accelerating deblock filtering of the deblock unit if it is determined that the total time taken exceeds the target time value at the comparison step.

### TECHNICAL FIELD

The present invention relates, in general, to a video decoder for generating restored pictures through the decoding of video data compressed and transmitted by an encoder and reproducing them and, more particularly, to a method of simplifying a decoding process according to predetermined logic when the remaining time is shorter than the required absolute time during the monitoring of the decoding status of a decoder, thereby securing the time required for decoding, and to the structure of the decoder therefor.

### BACKGROUND ART

Generally, only when a video decoder for decoding compressed moving pictures can restore respective frames of a moving picture to be restored within a predetermined time, a terminal system can reproduce the moving picture with smooth scene changes.

If an interval of time longer than a tolerable limit is taken for the restoration of any one specific frame, the terminal system cannot display a corresponding scene on a screen in time, or the picture quality and reproduction of subsequent frames are affected thereby. In this case, in the prior art, the required absolute time was generally ensured using a method of unconditionally omitting some frames. However, the reproduction based on decoding in which some frames are omitted creates an unpleasant feeling due to discontinuous upon scene changes or the serious distortion of pictures.

As described above, a conventional video decoder or a video terminal generally omits a corresponding frame or replaces the frame with a previously restored frame at the time at which a problem occurs without using a separate solution when a picture is not restored within a reference time because the performance of such a system does not reach a desired level or the performance of the terminal is limited in a specific environment, so that a problem occurs in that relatively poor picture quality results.

Therefore, in order to ensure as uniform a reproduction frame rate as possible in a system, such as a portable terminal, in which hardware performance is limited or distributable performance resources are limited due to specific conditions, it is necessary to provide a video decoder having a very effective acceleration function for actively dealing with a problematic situation under corresponding conditions and minimizing deterioration of picture quality through the maximum use of limited resources.

### DISCLOSURE

### Technical Problem

Accordingly, the present invention has been made keeping in mind the above problems occurring in the prior art, and an object of the present invention is to provide the structure of a video decoder system and a method for operating the same, in which, when a situation in which a moving picture cannot be reproduced at an original frame rate arises due to limited performance of a terminal, a decoder control unit, which is notified of the situation by a monitoring system which monitors the situation, controls picture quality in steps by appropriately adjusting the intensity and application means of an available method depending on the extent of limitation of performance thereof, thereby achieving intended decoding quality.

### Technical Solution

In order to accomplish the above objects, the present invention provides a method of operating a decoder system for decoding video frames using deblock means for deblock-filtering encoded video frames and a decoder control unit for controlling the deblock means, the methods comprising the steps of the decoder control unit receiving a target time value to be taken to decode a frame; the decoder control unit performing main processing including inverse transformation and motion prediction on a predetermined frame; the deblock means providing a value of time taken to perform deblock filtering on a frame prior to the predetermined frame, to the decoder control unit; the decoder control unit comparing a value of total time taken, in which the received value of time taken for the deblock filtering of the previous frame and the value of time taken for the main processing are added, with the target time value; and the decoder control means accelerating deblock filtering of the deblock means if it is determined that the total time taken exceeds the target time value at the comparison step.

Additionally, the present invention provides a method of operating a decoder system for decoding video frames using main processing means including motion prediction means for predicting motions for partial frames resulting from division of a video frame, and inverse transformation means for performing inverse transformation on the partial frames, a main processing performance analysis unit for monitoring performance of the main processing means, and a decoder control unit for controlling the main processing means, the method comprising the steps of the decoder control unit receiving a first target time value to be taken to decode a frames; the decoder control unit acquiring a second target time value by subtracting time taken to perform post-processing including deblock filtering for a previous video frame from the first target time value; the decoder control unit acquiring an average main processing time value which is required to perform the main processing including the motion prediction and the inverse transformation for each partial frame by dividing the second target time value by the number of partial frames; the main processing means performing the main processing on a predetermined video frame and, simultaneously, the main processing performance analysis unit monitoring performance of the main processing means and notifying the decoder control unit thereof; the decoder control unit calculating a value of time to be taken to perform main processing on remaining partial frames on which main processing is not performed, based on the performance of the main processing means, and calculating a third target time value obtained by multiplying the average main processing time value by a number of remaining partial frames; the decoder control unit comparing the value of the main processing time to be taken with the third target time value; and the decoder control means accelerating the main processing of the main processing means if the value of the main processing time to be taken exceeds the third target time value at the comparison step.

Additionally, the present invention provides a method of operating a decoder system for decoding video frames using main processing means including motion prediction means for predicting motions for partial frames resulting from division of a video frame, and inverse transformation means for performing inverse transformation on the partial frames, a main processing performance analysis unit for monitoring performance of the main processing means, and a decoder control unit for controlling the main processing means, the method comprising the steps of the decoder control unit receiving a first target time value to be taken to decode a frames; the decoder control unit acquiring a second target time value by subtracting time taken to perform post-processing including deblock filtering for a previous video frame from the first target time value; the decoder control unit acquiring an average main processing time value which is required to perform the main processing including the motion prediction and the inverse transformation for each partial frame by dividing the second target time value by the number of partial frames; the main processing means performing the main processing on a predetermined video frame and, simultaneously, the main processing performance analysis unit monitoring performance of the main processing means and notifying the decoder control unit thereof; the decoder control unit calculating a value of time taken to perform main processing up to a current time, and calculating a third target time value obtained by multiplying the average main processing time value by a total number of partial frames up to a current partial frame; the decoder control unit comparing the value of the main processing time to be taken with the third target time value; and the decoder control means accelerating the main processing of the main processing means if the value of the main processing time to be taken exceeds the third target time value at the comparison step.

### Advantageous Effects

The present invention relates to a method and system which monitor respective means needed for decoding in real time at the time of decoding video frames, analyze the respective performance thereof and determine means to be accelerated by a decoder control unit, and a method for the acceleration, based on the analysis, thereby smoothly reproducing a moving picture without omitting any frames.

Even if the hardware performance of a decoding terminal is insufficient, the user of the present invention is advantageous in that a moving picture is smoothly and acceptably reproduced without serious degradation of picture quality.

In detail, the present invention analyzes the performance time of a terminal decoder in real time, simplifies and selectively omits calculation steps in ascending order of degradation in picture quality in consideration of the status of a processor, based on the analysis, thereby enabling a natural moving picture service at optimal picture quality for a given level of performance even under the condition of restricted performance resources.

Even in a system environment in which the ability to reproduce a moving picture at a uniform frame rate is slightly insufficient, or the amount of processing is large, the present invention actively deals with given conditions, so that there is an advantage of ensuring smooth reproduction of a moving picture. As a result, the present invention has advantages of improving and stabilizing picture quality in a video terminal and simultaneously guiding and controlling effective distribution and application of system resources. When the video terminal distributes the system resources to respective modular function units, such as an audio unit, a video unit, a user interface unit, a screen display unit, and a system control unit, and controls them, the present invention effectively restricts a decoder unit, thereby enabling the effective control of the other functional units.

Experimental values representing the advantages of the present invention are illustrated in FIG. 9.

FIG. 9 illustrates a comparison of the number of frames decoded per unit time by a decoder to which the algorithm of the present invention is applied with that of a general decoder on the assumption that the rate of input data is the same as the frame rate of video signals, that is, 15 frames per second (15 fps). If decoding can be performed faster than 15 frames per second, a picture that is identical to an original picture restored through a normal decoding procedure can be acquired. In contrast, if not, various means proposed in the present invention are employed, so that a video picture is restored at the originally intended frame rate such that deterioration of picture quality is minimized and the calculation time is reduced.

FIG. 10 again illustrates the results of comparing degrees of calculation amounts in respective frame periods. In the application of the present invention, assuming, for example, that a system has the degree of ability to assign processor resources to a video decoder unit, that is, 120 MIPS (Million Instructions Per Second), the algorithm of the present invention is applied at the time point at which the amount of calculation exceeds a predetermined limit, thereby correspondingly adjusting the performance of the decoder to a value around 120 MIPS. As a result, the present invention provides effective maximum use of limited performance resources, so that it can be known that it is possible to adjust the performance of the video decoder under such conditions.

According to the present invention, various modifications can be made. The modifications can easily be derived from the present invention by those skilled in the art, and thus the actual scope of the present invention is not limited to the above-described embodiments.

### DESCRIPTION OF DRAWINGS

FIG. 1 is a block diagram illustrating a system according to the present invention;

FIG. 2 is a flowchart illustrating the entire concept of the present invention;

FIG. 3 is a conceptual diagram illustrating time values used in the present invention;

FIG. 4 is a flowchart illustrating a process of determining whether acceleration is required in a post-processing means according to the present invention;

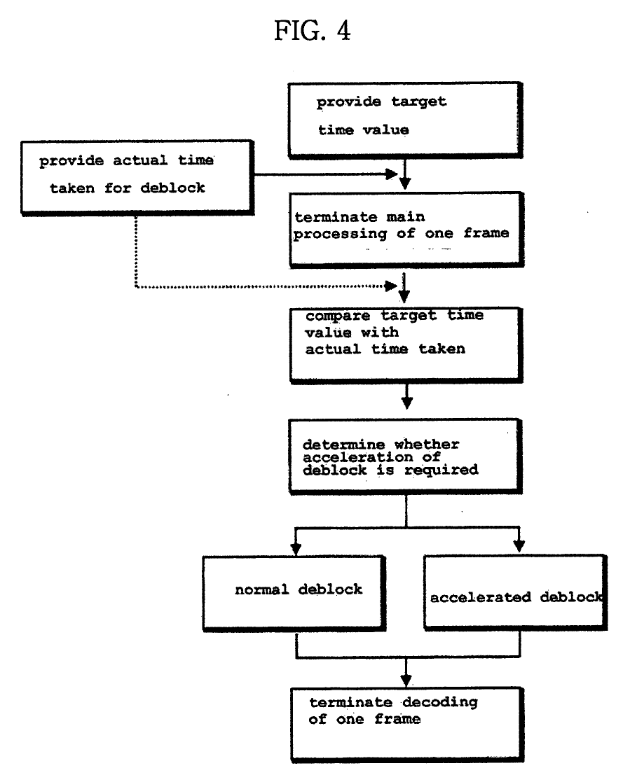

FIG. 5 is a flowchart illustrating a process of determining whether acceleration is required in a main-processing means according to the present invention;

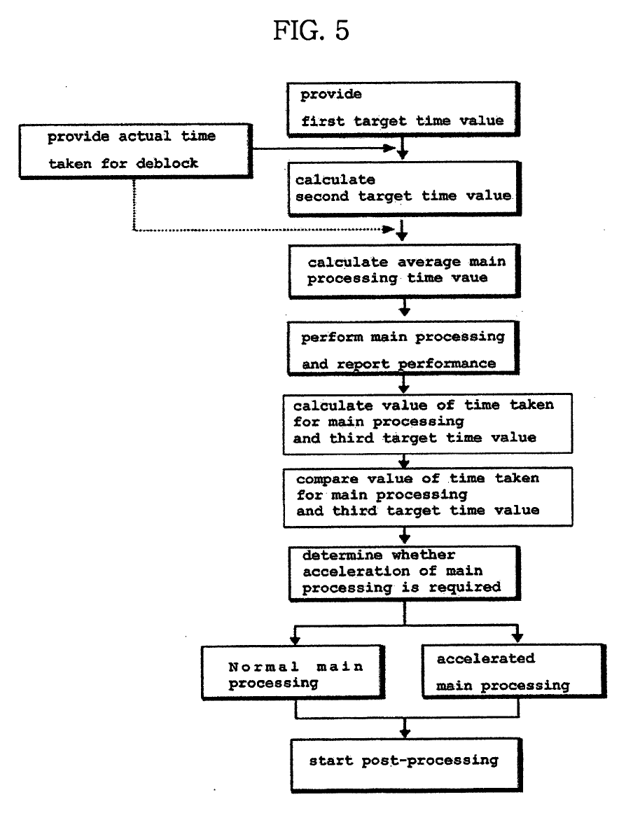

FIG. 6 is a flowchart illustrating integrated control in the main processing means;

FIG. 7 is a flowchart illustrating integrated control in the post-processing means;

FIG. 8 is a flowchart illustrating the real-time measurement and control of the present invention;

FIG. 9 is a diagram illustrating experimental data showing the advantages of the present invention; and

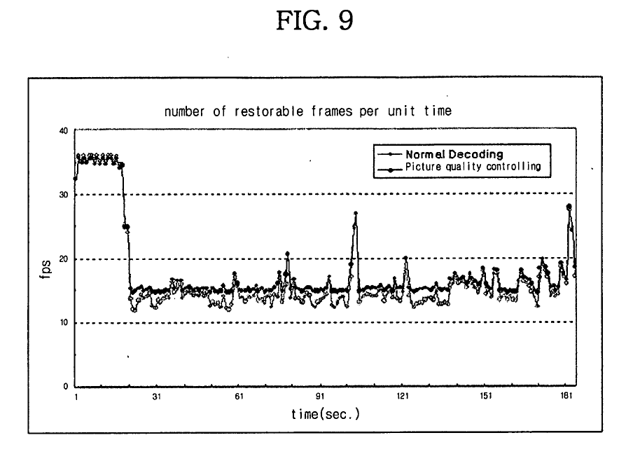

FIG. 10 is a diagram illustrating more experimental data showing the advantages of the present invention.

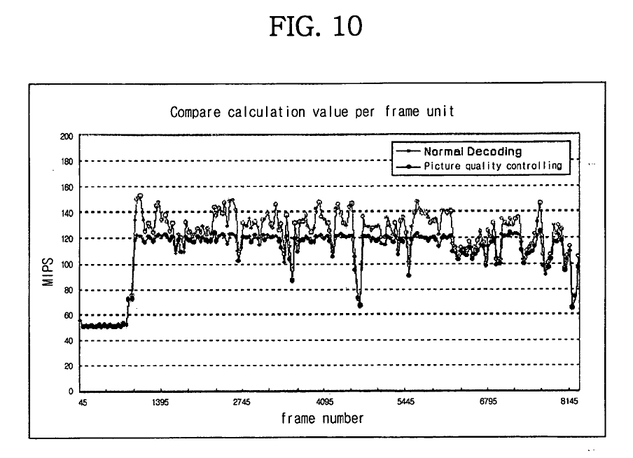

### BEST MODE

Preferred embodiments of the present invention are described in detail with reference to the drawings below.

First of all, a video decoder system according to the present invention is composed of a decoder, a performance analysis unit for the decoder and a decoder control unit for performing control such that decoding steps are selectively performed in conjunction with the analysis unit.

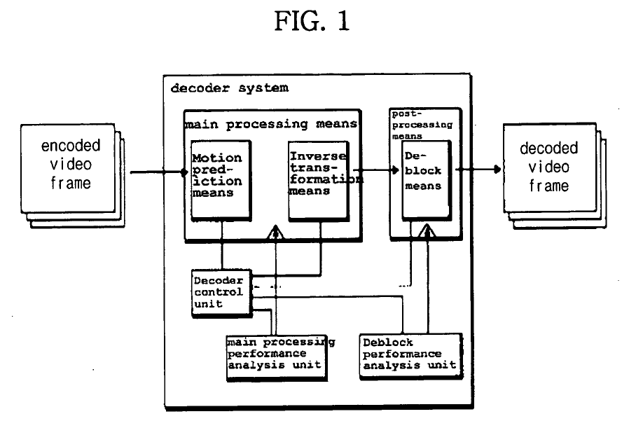

In FIG. 1, the decoder system is divided into a main processing means for processing data on a macroblock (hereinafter referred to as an MB) or slice basis, and a post-processing means for performing in-loop deblock filtering or the like on the entire frame. Performance analysis units for monitoring respective means and a decoder control unit for being notified of the performance of respective means and determining and controlling whether to accelerate respective means are included therein. In the present invention, “a partial frame” is used as a term indicating an MB and a slice in common.

Meanwhile, the main processing means includes a motion prediction means for receiving encoded video frames and performing intra prediction, inter prediction and compensation steps for each partial frame, and an inverse transformation means. The post-processing means includes a deblock means.

For all of the respective means, or at least the inverse transformation means and the deblock means, a performance analysis unit includes a partial frame performance analysis unit for monitoring and measuring the performance thereof, and a deblock performance analysis unit is connected thereto.

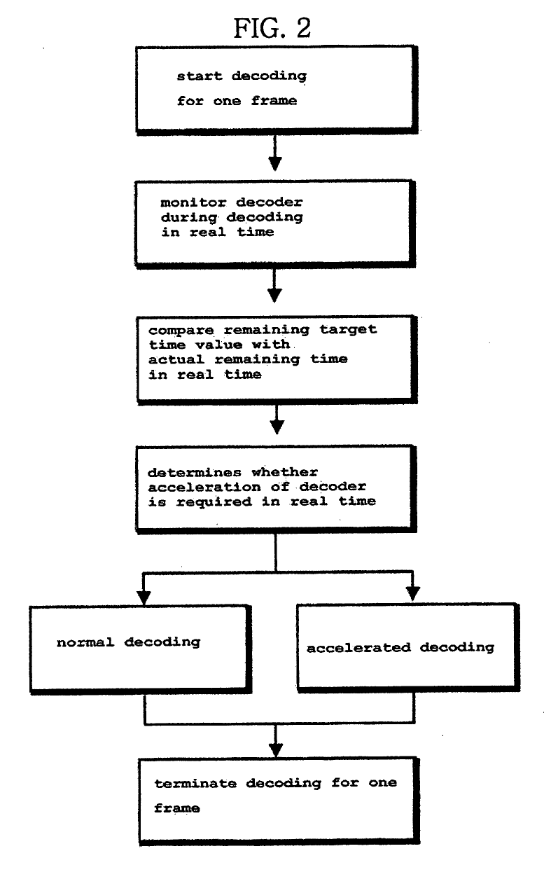

FIG. 2 is a flowchart conceptually illustrating the method of operating the decoder control unit of FIG. 1.

When the decoder system of the present invention starts to decode a video frame, the motion prediction means and the inverse transformation means perform motion prediction, compensation and inverse transformation for each partial frame (thereinafter collectively referenced to as a main processing step). Thereafter, when the main processing step has been performed on an entire frame, the deblock filtering of borders existing between respective partial frames based on selected options for an standard encoding scheme or an encoding method, and subsequent processing tasks are performed. The subsequent processing tasks including the deblock filtering are called a “post-processing process”, to be distinguished from the above-described main processing process.

Upon performance of the main processing step and the post-processing step, the performance analysis units count and analyze the time required to process video data and then transmit information thereof to the decoder control unit while monitoring time required for performance and reserved processing abilities of the current processors of respective means connected thereto.

The decoder control unit calculates time to be taken in the future, that is, time (hereinafter referred to as a remaining target time value) to be taken to perform main processing or post-processing on each frame after a specific partial frame, based on information about the performance of respective means received from the performance analysis units, compares the calculated time with actual remaining time, and performs control such that at least one of the main processing means and the post-processing means undergoes an acceleration step when it has been determined that the actual remaining time is less than the remaining target time value. In the acceleration step, which level or which method is applied thereto is determined according to an algorithm defined in the present invention.

In the actual application of the present invention, the detailed content thereof may differ depending on video signal encoding standard methods. That is, the analysis of performance time and whether a target to be processed has a frame unit, a slice unit, a MB unit, or a composition unit of any other picture are differently selected and used to be suitable for the situation and the conditions, or the combinations thereof may be applied. As described above, the MB or the slice which is part of a frame or a similar construction are all called partial frames in common. Furthermore, at the comparison step, the time that can be taken for a corresponding partial frame is compared with time that is actually taken for the corresponding partial frame, instead of comparing the remaining target time value with the actual remaining time. If the latter exceeds the former, the acceleration step may be performed.

In the description of an embodiment of the present invention, a video decoder based on H.264 (or MPEG-4 AVC) is taken as an example. However, general standard video signal encoding methods are based on structures similar to that of H.256, therefore application to existing and future standards can be also implemented using methods identical to or similar to that of the present invention. Therefore, the present invention is not limited to the H.256 standard.

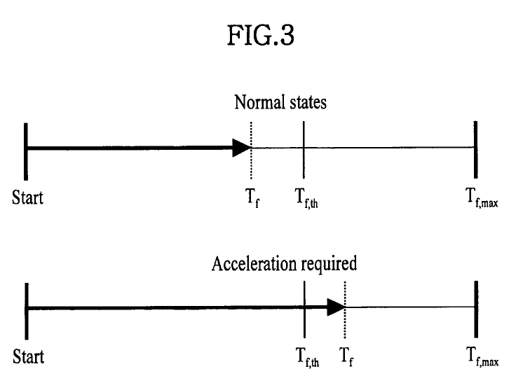

FIG. 3 is a conceptual diagram illustrating performance time in the case in which observation and control is performed on a frame basis.

Tf designates an actual performance time for an entire current frame, Tf,th is a threshold value or target time value as a predetermined reference required time for one frame. Therefore, if Tf exceeds Tf,th, it means that it is impossible to decode the corresponding frame within a predetermined time.

As described above, if the decoder control unit, which is informed of data about the performance times of respective means by respective modules of the performance analysis unit which monitors the motion prediction means, the inverse transformation means and the deblock means for an entire frame with respect to the decoder for processing respective partial frames, and checks this in real time, determines that Tf exceeds Tf,th after a specific partial frame, an acceleration method according to the algorithm of the present invention is applied to partial frames subsequent to the corresponding partial frame.

Furthermore, when, even after the acceleration, decoding processing time for a certain frame, that is, Tf exceeds Tf,th, the present invention operates such a way to borrow and use some of the target time value to be used by a frame subsequent to the certain frame for the processing of the certain frame, and use only the remaining target time value for the subsequent frame for the decoding of the subsequent frame.

Tf,th is a value which may be appropriately adjusted by the designer or user of terminal depending on the environment of the terminal, but is generally determined as in the following equation when frame rate per second is fs.

Tf,th=1/fs−α=1/(fs+k)

where, 1/fs−Tf,max<α<1/fs, and k>1/Tf,max−fs.

α and k values of the above equation are experimentally set values, and values differently applied depending on the frame type (I, P, B) and the current status of the decoder.

Furthermore, Tf,max is the maximum tolerable time which decoding time per frame must not be excessive. If exceeded, the terminal cannot output a current frame to the screen within a desired time, thereby hindering the smooth reproduction of a moving picture.

Tf,mas is described in detail below. If the time for storage and output to a screen is negligible, the time is generally considered as a storage buffer for recent restored pictures of a decoder and a terminal. That is, when the number of frames which can be stored in the inside of the respective means of the decoder or buffer memory mounted in the stage prior thereto is Bf, the following equation is set.

Tf,max=Bf/fs

That is, Tf,max is proportional to the amount of buffer memory, and becomes shorter as the number of frames to be processed per second is greater. Therefore, if Tf,max is set to a large value, Tf,th value is also set to a large value, so that the possibility of controlling the performance of the decoder at a target frame rate is larger and easier even when overall performance speed is lowered. However, in the communication environment of real-time encoding and real-time decoding, as in picture communication, a time difference between a transmitter and a receiver that falls outside of a limit prevents smooth communication, so this value cannot be set to an unconditionally large value.

The calculation-required time Tf per unit frame is divided for each of the encoding steps including deblock filtering, inverse transforming, motion prediction and compensation, and, therefore, can be represented as the following equation:

Tf=Tf,deblock+Tf,pred+Tf, itrans+Tf, etc

In the above equation, with respect to respective right variables, Tf,deblock designates the time that is taken for deblock filtering and counted for one frame, Tf,pred designates time taken for a motion prediction and compensation step, Tf,itrans designates time taken for IDCT, that is, inverse transformation step, and Tf,etc designates time taken for the other steps.

Time Tf,deblock taken for the deblock filtering step is again divided into time Tf,deblock/Y taken for the deblock of luma and time Tf,deblock/c taken for the deblock of chroma. Likewise, Tf,pred and Tf,itrans can be divided into processing times for respective processing luma and chroma.

Embodiments of the present invention are described in detail below.

### MODE FOR INVENTION

### First Embodiment

### Acceleration of Deblock Filtering

One of the representative embodiments of the present invention is a method using accelerated filtering at a deblock filtering step. The reason for this is that the deblock filtering requires a large amount of computational work and affects picture quality somewhat less than the other restoring steps.

The example of implementation and application of H.264, which is an example of the present invention, is described. First, the decoder control unit receives a target time value Tf,th taken to decode a frame, or calculates it by oneself. In this case, “provision” means the state in which the decoder control unit has the target time value, and is used to include that a predetermined value is provided from another device and that it is obtained from its own statistical data or through calculation.

Thereafter, the inverse transformation and the motion prediction and compensation are performed on the partial frames of a frame to be currently decoded (hereinafter referred to as the frame of time t). In this step, an acceleration method for partial frames which will be described may or may not be used.

Furthermore, a time value Tf,deblock to be taken to perform the deblock filtering, or a post-processing step that includes it, before or after the main processing step is provided. The time value can be used to include a time taken to perform only the deblock filtering or a time required for any other post-processing additionally thereto.

The actual time Tf,deblock taken for the deblock filtering is provided to the decoder control unit or is calculated through one of many methods, one of which is that the decoder control unit stores or is provided with and then uses the average time taken to perform deblock filtering on a frame (frame of time t−1 or frame of time 0˜t−1) prior to the current frame (frame of time t), or the time taken to perform the deblock filtering for a specific frame, such as a most recent frame among previous frames.

Then, at the post-processing step including the deblock filtering, the remaining target time, resulting from subtracting the time taken to perform the main processing step from a target time required for the post-processing step, that is, the target time value Tf,th, upon the start of the deblock filtering, is compared with a required time value Tf,deblock, and then whether to normally perform the deblock filtering or to replace the deblock filtering with an alternative high-speed filter approximating the deblock filtering in a specific direction is determined.

After the determination step has been conducted, the deblock means performs deblock filtering on predetermined video frames. The deblock filtering may be any one of an accelerated filter or a normal filter.

As described above, the easiest method of controlling picture quality to improve the speed of the decoder system of the present invention is to control the degree of frame-based deblock filtering, which can be determined using data about time taken for a previous frame. That is, on the assumption that a frame has a tendency similar to that of a previous frame when the frames are of the same type (I or P), calculation times estimated to be taken for respective steps are estimated from the decoding step of a previous frame.

In the case of an H.264 decoder, the amount of calculation occupied by the deblock filtering step is occasionally more than 30˜40% of the total amount, so that in many cases, speed is sufficiently improved only through control to simplify the deblock filtering step. Furthermore, although the deblock filtering is simplified or becomes simpler, the loss of picture quality is relatively small.

### Second Embodiment

### Acceleration Method 1 of Partial Frames

When the available time of a processor is insufficient in spite of the acceleration of the deblock filtering, a more powerful means must be additionally provided, which also takes into account that the degree of deterioration of picture quality increases. For example, when it is determined that during performance of decoding on a certain partial frame prior to deblock filtering, time actually taken up to the certain frame exceeds a time limit which should be taken up to the certain frame, the acceleration step is necessarily performed on partial frames subsequent to the certain frame.

This process is described in detail below.

A step of providing a first target time value, which the decoder control unit can take to decode one video frame, is performed before and after the start of decoding for a specific frame. The first target time value Tf,th is the total time that can be taken for the main processing and the post-processing as described above. Furthermore, the target time value is previously provided by a user or a designer, or the decoder control unit calculates it by itself, thereby acquiring it.

Thereafter, a step of acquiring a second target time value resulting from subtraction of time taken to perform the post-processing step including deblock filtering for previous video frames from the first target time is performed.

This step is for acquiring time taken to perform only the main processing step, so that the post-processing time for previous frames is subtracted from the first target time value, that is, Tf,th, thereby acquiring the second target time value, Tf,th−(Tf,deblock+Tf,etc).

In more detail, if it is assumed that time Ttf,deblock taken to perform subsequent deblock filtering after the motion prediction, the compensation and the inverse transformation step for the partial frames of a frame at predetermined time t is identical to time Tt−1f,deblock taken to process previous frames, time T′f,mb assigned to the processing of partial frames among total processing time Tf,th assigned to a corresponding frame is the following:

T′f,mb=Tf,th−Tt−1f,deblock

T′f,mb is an example of the second target time value.

Thereafter, the decoder control unit divides the second target time value by the number of partial frames and acquires an average main processing time value required to perform the main processing step including the motion prediction and the inverse transformation for partial frames.

The average main processing time value is the main processing target time value which can be used to perform the main processing for each frame, and, for example, the average main processing time value T′f,mb/N for each MB when each of the partial frames is composed of N MBs.

Before and after the step of obtaining such fundamental time values, the main processing means performs the main processing step on predetermined frames of the video frames. Furthermore, during performance of the main processing step, the main processing performance analysis unit monitors the performance of the main processing means and notifies the decoder control unit thereof.

A step in which the decoder control unit calculates, in real-time, the value of the main processing time required to main process the remaining partial frames, which have not been processed yet, of all partial frames of a predetermined frame, and a third target time value in which the average main processing time value is multiplied by the number of remaining partial frames based on the reported performance of the main processing means is performed.

The value of the time to be taken for main processing is the value of the main processing time predicted to be taken in the future, and can be obtained by calculating the average main processing time taken up to the current partial frame of a corresponding frame and then multiplying the result value by the number of the remaining frames. In contrast, the average main processing time value is calculated by subtracting the post-processing time value for the previous frames from the first target time value as described above, therefore it is the limit target value of time available for the main processing for partial frames in the future.

As a result, the decoder control unit compares the value of the time to be taken for main processing with the third target time value and, if it is determined that the value of the time to be taken for main processing exceeds the third target time value, it is estimated that the time to be taken in future main processing for partial frames exceeds the available time.

As a result, when estimating that such an excess phenomenon will occur, the decoder control unit performs the step of accelerating the main processing step by the main processing means and shortens actually required time.

The acceleration method is described below.

### Third Embodiment

### Acceleration Method for Partial Frames

Another method for acceleration of main processing is to compare time taken for partial frames up to the current time with an available time value at the above-described comparison step, rather than comparing time required for subsequent partial frames.

In more detail, a step of receiving a first target time value, a step of obtaining a second target time value and a step of calculating an average main processing time value are the same as or similar to that of the second embodiment. Furthermore, the step at which the main processing means performs the main processing step for predetermined frames of the video frames and, at the same time, the main processing performance analysis unit monitors the performance of the main processing means and notifies the decoder control unit of it, is a single step.

A characteristic feature is the performance of a step in which the decoder control unit calculates the value of the main processing time taken up to the current time, and a third target time acquired by multiplying the average main processing time value, by the total number of partial frames up to a current partial frame based on the reported performance of the main processing means. In this case, the third target time value is compared with the value of the time taken for main processing taken up to a current partial frame and, unlike the second embodiment, is the available target time value up to the current partial frame. The decoder control unit compares the value of the time taken for main processing with the third target time value, and, if the value of the time taken for main processing exceeds the third target time value, the step of accelerating the main processing step is performed by the main processing means.

### Fourth Embodiment

### Integrated Control for Acceleration of Main Processing and Post-processing

The above-described embodiments all relate to a method of determining the acceleration for main processing and post-processing.

However, the decoder control unit of the present invention may integrally control the acceleration step for both the main processing means and the post-processing means. An embodiment for such integrated acceleration control is briefly described below.

In the present invention, the integrated control for acceleration of decoding is represented in the form of a combination of the first embodiment, the second embodiment and/or the third embodiment.

In detail, before the main processing for frames, the time required for post-processing is previously subtracted from a target time value, that is, Tf,th, thereby obtaining a target time value available for the main processing, and then whether the available time has exceeded the target time value is always checked while actual main processing is performed on partial frames, thereby determining whether acceleration is required for the main processing step.

Thereafter, after the post-processing has started, whether a value, in which time taken by the main processing unit and time required for post-processing are added to each other, exceeds the target time value is determined, and, if exceeded, a post-processing step is accelerated, thereby shortening total required time.

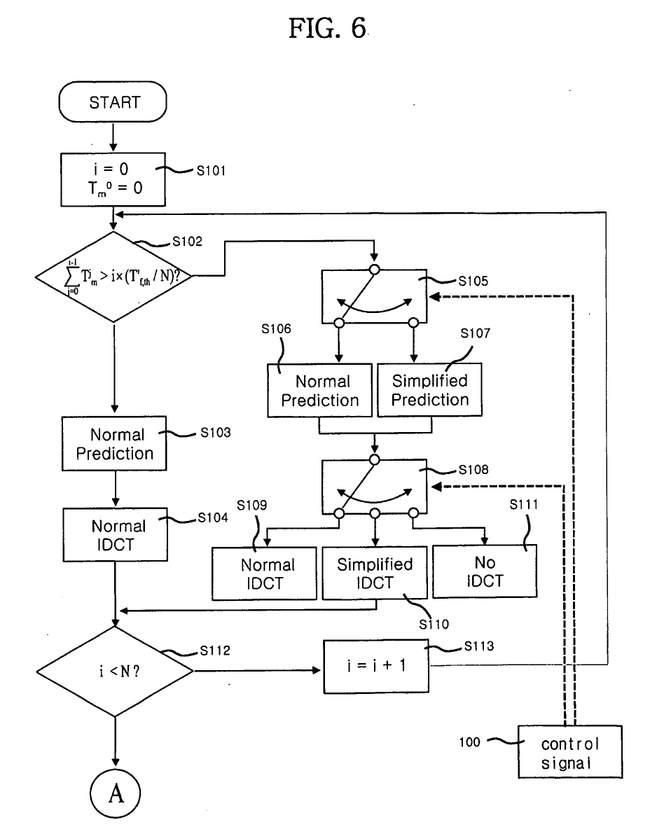

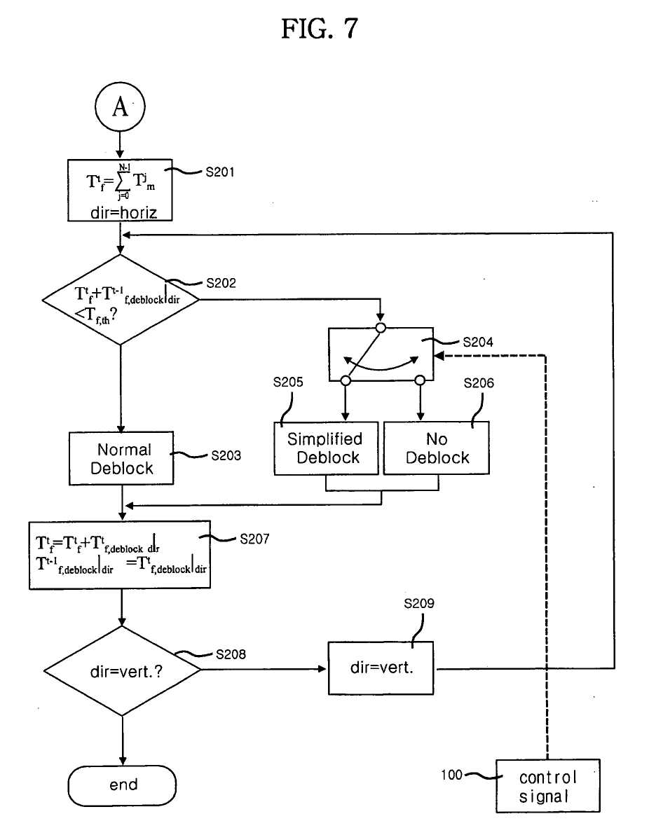

The specified situation for the integrated control is described with reference to FIGS. 6 and 7 below.

If decoding starts, an initialization step S101 is performed, and then the decoding of main processing is performed on a partial frame unit basis, that is, a slice basis or an MB unit basis. At the same time, the decoder control means determines when an acceleration function is applied at the start of main processing for partial frames at any specific moment based on the notification of the performance of the main processing performance analysis unit.

In detail, at step S102, time actually taken for any specific frame is compared with an available target time value.

The right-side and left-side equations for step S102 are described in detail. First, in the right-side equation, N designates the number of total slices or MBs constituting one frame, T′f,th designates time value in which time required for post-processing, that is, Tf,deblock or Tf,deblock+Tf,etc, is subtracted from total time required to process one frame and is a target time value available only for main processing.

T′f,th=Tf,th−-(Tf,deblock+Tf,etc)

In the above equation, since time which is being calculated in real time for post-processing of the decoder for a current frame can be generally known until the decoding of the last partial frame is completed, the post-processing time for a previous frame is used instead of the time, as described above. Whether a slice unit, MB unit or any other unit is used or whether a combination thereof is used is an option which a user can determine, and the above equation is also modified and then used depending on the situation. In the design of a system, it is taken into account that when calculation time is analyzed on a MB basis, additional calculation time is required, although not occupying a large portion.

As a result, the number of partial frames, on which main processing has been performed up to a current time, is i, so that the right side of the equation is the target time value to be taken up to a current partial frame.

Meanwhile, in the left side of the equation, Tjm represents calculation time taken for the main processing of a j^{th} partial frame, so that the left equation of step S102 means the time actually taken for the main processing from the first to a current i^{th} partial frame.

As a result, if time actually taken for any specific frame is less than or equal to an available target time value at step S102, the decoder control unit continues to perform normal main processing through steps S103 and S104, but, if the time actually taken for any specific frame is greater than the available target time value, the decoder control unit performs control such that acceleration steps after step S105 are performed.

That is, in the case in which calculation is performed sufficiently rapidly, so that the condition of step S102 is not satisfied, the original normal decoding procedure is performed, thereby providing the same result as the normal result to a subsequent step. If the condition of step S102 is satisfied, acceleration steps, which correspond to steps S107, S110 and S111, determined at a corresponding control level, are performed.

Step S105, which is a switching step, is for determining to which step the process will proceed based on the control signal 100 from the decoder control unit. The control signal is the signal which controls the operation of the system after the level of solution that is to be applied based on previous data and statistical data is determined. Step S108, to be described below, is similar thereto.

The step of fetching an estimated picture region is step 106 or 107. Step S106 is the same step as a normal 20 step, and step S17 is the step to which acceleration is applied through simplification of a calculation formula. The simplification of a calculation formula, the degree of application intensity or the like may be again applied based on different criteria depending on the situation at step S107.

The step of inverse-transforming a transformation coefficient is step S109, S110, or S111. The process is switched to any one step of the steps via a switch S108 through determination using the degree of acceleration and an external control signal depending on the purpose. Step S109 is the same inverse-transforming step as the original step. Step S110 is the step of performing acceleration using a high-speed calculation formula using a low-frequency band of coefficient information while ignoring the high-frequency band. Step 111 ignores all coefficient information and omits the inverse-transforming step. In step S110, the low-frequency band of interest can be set differently depending on the situation. When applied to H.264, for example, the inverse-transformation is performed on only the low-frequency band based on a 2×2 transformation equation, instead of a 4×4 transformation equation.

A method of improving speed which can be applied at the level of slice or MB is to decrease Titrans and Tpred. On the assumption that the optimization of the algorithm has been completed, the method of further decreasing Titrans first comprises ignoring high-frequency components from coefficient information and creating restored pictures using only low-frequency components. Depending on the situation, the bandwidth of related coefficients can be regulated, and if the performance of a processor is low, and a more powerful means is required, it is possible to ignore coefficient information other than DC information. The reason for this is that it can be seen that the loss of coefficient information has less effect on picture quality than the loss of predicted picture information.

The method of reducing the time of Tpred is to use alternative high-speed approximate calculation formulas. In the case of H.264, ¼ pixel unit based-motion vector values are provided through the somewhat complicated filtering of a 6-tap filter upon an inter mode, and respective calculation formulas are replaced with simplified approximate formulas. In an intra mode, a similar method is applied, thereby reducing calculation time, but the ratio of this to entire performance time is low, and the degradation of picture quality is propagated to a subsequent frame and accumulated, so that it is desirable to avoid this.

It is more beneficial to apply simplified calculations for coefficient information and motion information to chrominance information than to luminance information, if possible, from the standpoint of the degradation of picture quality. When the method is performed on the slice or MB basis, the picture quality of one frame is likely to be degraded in a manner visible to human's eyes, thus, in consideration of the characteristic of moving pictures in which scene changes are rapid, the quality of moving pictures is not good.

In the order of application, the effective bandwidth of a coefficient is first adjusted depending on the degree of performance, and, if a further reduction of time is required, the scheme of deriving predicted information using a simplified formula is used. The inverse order thereof is possible. They depend on the selection. A method of varying the order of application and the intensity thereof depending on the situation is also can be used.

In the case in which a solution stronger than the above-described solution is further required, the entire AC of coefficient information is ignored. Moreover, in the worst situation, a method which is similar to a general method of hiding simple errors and which ignores all vector values, all mode values and all coefficient values and reads pixel information located in the same position of a previous frame or peripheral pixel information unchanged can be used. However, the above-described application implies that the maximum time reduction amount that is theoretically possible is estimated, and in practice does not match the purpose of smooth coupling of scenes through the control of picture quality.

Alternatively, a method of restoring pictures to have resolution less than an original resolution, and again enlarging them to the original size, or displaying a small screen, may be employed. In this case, motion vector values can be approximated as simple values larger than the motion vector values, and high frequencies can also be ignored. In particular, this is efficiently applied to display on a terminal having a screen that has a lower resolution than the original resolution. If scalability coding is applied to moving picture data at the decoding stage, it becomes easier to control the decoding speed through picture quality. The data of a base layer is more faithfully restored using any one of the temporal scalability decoding method, spatial scalability decoding method and Signal to Noise Ratio (SNR) scalability decoding method. The data of an upper layer (enhancement layer) may be omitted or relatively briefly restored, thereby resulting in the reduction of calculation time. This method is a general method which can be used in the case in which transmission bandwidth is restricted or other functions are restricted, and can be applied to the decoder stage only when a signal is compressed according to the method at a decoding unit.

As an alternative method of even further reducing the amount of calculation, a method of additionally simplifying other calculation formulas, for example, replacing a round-off operation with a cut-off operation, can be considered. The present invention does not specify any simplified high-speed fixed formula upon construction of the loop filter and determination of the predicted information. An appropriate formula must be used suitably for the user environment, and setting determination reference values is also an item which can be regulated suitably for system conditions. The above-described implementation examples can be applied to existing or future standards besides H.264 with little modification in a similar approach.

When normal steps S103 and S104 and acceleration steps S105 to S111 have been conducted, whether a current partial frame has reached a total number N is determined at step S112. If it has not been reached, it means that unprocessed partial frames still exist, so the above-described main processing step is repeatedly performed after step S113 has been executed.

When the main processing step has been completed for all partial frames, the process proceeds to the post-processing step, that is, deblock filtering of FIG. 7, which corresponds to the deblock filtering part of H.264. This is shown in FIG. 7.

In the flowcharts of FIGS. 6 and 7, according to the order thereof, acceleration is first performed on a partial frame basis and regulation is then performed on a frame basis, as in deblock filtering. However, the illustrated steps are based on the decoding order, rather than the priorities of actual acceleration steps. Actually, as described above, since T′f,th, from which the predicted calculation time of deblock filtering is previously subtracted, has been used, deblock filtering, in which the influence on picture quality is little in theory, is preferentially performed, thereby accelerating decoding.

Ttf of steps S201, S202, and S207 is a value representing total time taken from the start of decoding up to a current time with respect to the frame of the current time t. Tt,deblock designates the calculation time of deblock filtering taken for the current frame. Tt−1f,deblock of steps S202 and S207 means calculation time taken for the deblock filtering of a previous frame.

Using Ttf,deblock results in more precise control. However, since deblock filtering for the current frame has not started, the time value thereof cannot be known, so that Tt−1f,deblock of the previous frame is used.

Whether a normal step is to be performed, the high-speed loop filter is to be used, or the step is to be omitted is determined based on the calculation performance time at step S202. If it is determined that the acceleration of post-processing is necessary, a switch S204 determines the degree of application according to the control signal 100.

In order to accelerate the loop filter, although the resultant values thereof are somewhat different, alternative high-speed approximate formulas, which artificially simplify the complicated operation step and conditional examination formula of a conventional H.264 loop filter, or are used instead of the entire filter, thereby eliminating a blocking artifact between blocks, can be used.

A filter for obtaining a weight average between pixels can be considered as the most simplified approximate formula. In the case in which the simplified filter or the approximate formula is used, the difference between the performance time thereof and the performance time of the normal step is estimated with reference to material experimentally built in advance, so that the degree of the acceleration step or the acceleration method that is used are determined based on the difference when the acceleration step is required. The acceleration step can be differently applied to the horizontal direction and the vertical direction of a frame. When it is predicted that time is still lacking after the above described simplification and approximation, the acceleration step in any one of both directions can be omitted, or the acceleration step in both directions can be omitted in a poorer environment.

When the deblock filter has been completed with respect to either the horizontal direction or the vertical direction of a frame, the coefficients are again initialized at step S207. Before and after the initialization, whether the deblock filtering has been completed with respect to all directions is determined at step S208. If not completed, the new direction of deblock filtering is designated at step S209, and then the above-described steps are repeatedly performed.

An integrated acceleration step can be controlled through the above-described steps of FIGS. 6 and 7. It can be seen that FIGS. 6 and 7 illustrate the embodiments of respective acceleration steps of main processing and post-processing in detail.

### Fifth Embodiment

### Acceleration Control Based on Real-time Measurement

Still another embodiment of the present invention relates to a method of calculating whether time is excessive while decoding a frame in real time, and then controlling acceleration. In detail, when processing time remains or is insufficient at a previous decoding step, this is applied to a subsequent decoding step, thereby resulting in more integrated acceleration control and decoding control.

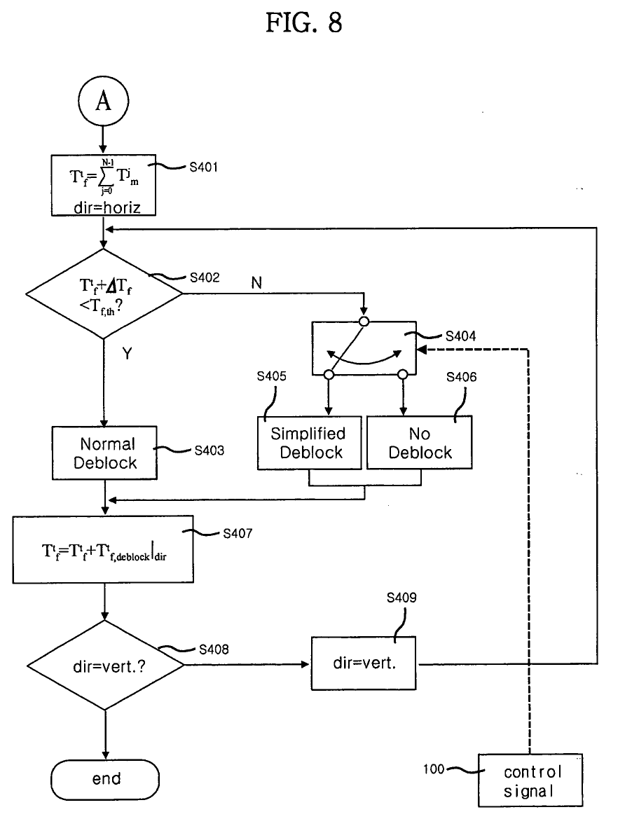

FIG. 8 illustrates an example of the above-described step. For example, when there is a difference between an actual performance time and a target time value upon decoding of a previous frame, whether acceleration of the main processing or the post-processing is required is determined based on the difference. When the decoding of a corresponding frame has been finally completed, the difference between the actual performance time and the target time value is again calculated, and is then carried forward to the decoding step of a subsequent frame.

In more detail, the main processing step for a current frame is first terminated at step S401, and Ttf is set as actual time taken.

Thereafter, a value (left side of the equation) resulting from adding time Ttf taken for the main processing step up to a current time before the post-processing with the difference ΔTf between the target time value and the actual performance time for a previous frame, is compared with a target time Tf,th, available up to the current time, thereby determining whether acceleration is required. If the difference ΔTf has a negative value, it means that the previous steps were rapidly performed, thereby resulting in the generation of spare calculation time. The time difference is used for the decoding calculation at the current time.

Thereafter, the method of determining whether acceleration is required at this step is a method of integrally determining whether acceleration is required in consideration of whether there is remaining time or insufficient time as a result of the processing of the previous steps, unlike previous embodiments.

Subsequent steps are identical or similar to those of the above-described embodiments. It should be noted that a step of subtracting the target time value from time Ttf, taken from step S410 to the current time, thereby acquiring remaining time or insufficient time for this frame, adding the time to the time difference ΔTf for the previous frame, thereby calculating a new time difference, and then using the new time difference for decoding a subsequent frame, is additionally provided. This step is the step of generating the new time difference in order to repeatedly perform the above-described steps for a subsequent frame.

The respective flowcharts of the present invention are conceptual, and thus the specific embodiments can be modified. For example, in the processing of the loop filter, whether normal processing is performed or not is determined for each direction of filtering in the embodiments, but, in actual applications, the degrees of application differ depending on color components (Y/C) or an inter or intra mode, besides the direction, which is more efficient or rational method. Furthermore, the calculation loop is repeatedly performed for each filtering direction, but is divided into details on slice basis or MB basis, and the degree of application is determined and performed.

### INDUSTRIAL APPLICABILITY

The operation method of a video decoder system according to the present invention can be applied to a video decoding device for decoding video data transmitted after being compressed, and generating and reproducing restored pictures.

1. A method of operating a decoder system for decoding video frames using deblock means for deblock-filtering encoded video frames and a decoder control unit for controlling the deblock means, the methods comprising the steps of:
the decoder control unit receiving a target time value to be taken to decode a frame;
the decoder control unit performing main processing including inverse transformation and motion prediction on a predetermined frame;
the deblock means providing a value of time taken to perform deblock filtering on a frame prior to the predetermined frame, to the decoder control unit;
the decoder control unit comparing a value of total time taken, in which the received value of time taken for the deblock filtering of the previous frame and the value of time taken for the main processing are added, with the target time value; and
the decoder control means accelerating deblock filtering of the deblock means if it is determined that the total time taken exceeds the target time value at the comparison step.

2. A method of operating a decoder system for decoding video frames using main processing means including motion prediction means for predicting motions for partial frames resulting from division of a video frame, and inverse transformation means for performing inverse transformation on the partial frames, a main processing performance analysis unit for monitoring performance of the main processing means, and a decoder control unit for controlling the main processing means, the method comprising the steps of:
the decoder control unit receiving a first target time value to be taken to decode a frames;
the decoder control unit acquiring a second target time value by subtracting time taken to perform post-processing including deblock filtering for a previous video frame from the first target time value;
the decoder control unit acquiring an average main processing time value which is required to perform the main processing including the motion prediction and the inverse transformation for each partial frame by dividing the second target time value by the number of partial frames;
the main processing means performing the main processing on a predetermined video frame and, simultaneously, the main processing performance analysis unit monitoring performance of the main processing means and notifying the decoder control unit thereof;
the decoder control unit calculating a value of time to be taken to perform main processing on remaining partial frames on which main processing is not performed, based on the performance of the main processing means, and calculating a third target time value obtained by multiplying the average main processing time value by a number of remaining partial frames;
the decoder control unit comparing the value of the main processing time to be taken with the third target time value; and
the decoder control means accelerating the main processing of the main processing means if the value of the main processing time to be taken exceeds the third target time value at the comparison step.

3. A method of operating a decoder system for decoding video frames using main processing means including motion prediction means for predicting motions for partial frames resulting from division of a video frame, and inverse transformation means for performing inverse transformation on the partial frames, a main processing performance analysis unit for monitoring performance of the main processing means, and a decoder control unit for controlling the main processing means, the method comprising the steps of:
the decoder control unit receiving a first target time value to be taken to decode a frames;
the decoder control unit acquiring a second target time value by subtracting time taken to perform post-processing including deblock filtering for a previous video frame from the first target time value;
the decoder control unit acquiring an average main processing time value which is required to perform the main processing including the motion prediction and the inverse transformation for each partial frame by dividing the second target time value by the number of partial frames;
the main processing means performing the main processing on a predetermined video frame and, simultaneously, the main processing performance analysis unit monitoring performance of the main processing means and notifying the decoder control unit thereof;
the decoder control unit calculating a value of time taken to perform main processing up to a current time, and calculating a third target time value obtained by multiplying the average main processing time value by a total number of partial frames up to a current partial frame;
the decoder control unit comparing the value of the main processing time to be taken with the third target time value; and
the decoder control means accelerating the main processing of the main processing means if the value of the main processing time to be taken exceeds the third target time value at the comparison step.
